(19) United States
(12) Patent Application Publication
(10) Pub. No.: US 2019/0304328 A1
(43) Pub. Date: Oct. 3, 2019

(54) METHOD AND APPARATUS FOR COLORED MUSIC NOTATION

(71) Applicant: Zi Hao QIU, Metuchen, NJ (US)

(72) Inventors: Zi Hao QIU, Metuchen, NJ (US); Christopher Dong Cheng QIU, Bridgewater, NJ (US); Tang YIN, Shanghai (CN)

(21) Appl. No.: 16/204,828

(22) Filed: Nov. 29, 2018

(30) Foreign Application Priority Data
Mar. 27, 2018 (CN) 201810282536.5

(51) Int. Cl. G09B 15/02

(52) U.S. Cl. CPC G09B 15/023

(57) ABSTRACT

An approach is provided for encoding musical information according to a music notation based on color. The approach involves designating a base octave of a musical note range comprising a plurality of octaves; wherein the base octave comprises a sequence of musical notes, the sequence of musical notes repeating in each of the plurality of octaves. The approach also involves representing the sequence as a set of colors, wherein each color of the set is unique to each note in the sequence of musical notes, wherein the music notation comprises representing a musical note as a shape that is colored according to the set, and wherein the shape is augmented with a modification of the set of colors, a symbol, or a combination thereof to indicate that the musical note is in the base octave, a lower octave than the base octave, or a higher octave than the base octave.

### RELATED APPLICATION

This application claims priority benefit to Chinese Patent Application Serial No. 201810282536.5, entitled “Colored Music Notation,” filed Mar. 27, 2018, which is herein incorporated by reference in its entirety.

### TECHNICAL FIELD

This present application relates to a music notation, in particular, to technology for encoding musical information.

### BACKGROUND

Many users enjoy listening to music. Many users also enjoy playing music (e.g., with an instrument or by singing). However, the complexity of conventional music notation (e.g., staff notation or numbered notation) makes it difficult for users with limited musical experience to read such music notation and to know how to play the corresponding music. This problem is intensified for young users such as children. Accordingly, service providers face significant technical challenges to offer an approach for users to effectively and efficiently read music notation so that they can play the corresponding music.

### SOME EXAMPLE EMBODIMENTS

Therefore, there is a need for an approach for encoding musical information according to a music notation based on color.

According to one embodiment, a computer-implemented method for encoding musical information according to a music notation comprises designating a base octave of a musical note range comprising a plurality of octaves; wherein the base octave comprises a sequence of musical notes, the sequence of musical notes repeating in each of the plurality of octaves. The method also comprises representing the sequence of musical notes as a set of colors, wherein each color of the set of colors is unique to each note in the sequence of musical notes, wherein the music notation comprises representing a musical note as a shape that is colored according to the set of colors, and wherein the shape is augmented with a modification of the set of colors, a symbol, or a combination thereof to indicate that the musical note is in the base octave, a lower octave than the base octave, or a higher octave than the base octave.

According to another embodiment, an apparatus for encoding musical information according to a music notation comprises at least one processor, and at least one memory including computer program code for one or more computer programs, the at least one memory and the computer program code configured to, with the at least one processor, cause, at least in part, the apparatus to designate a base octave of a musical note range comprising a plurality of octaves; wherein the base octave comprises a sequence of musical notes, the sequence of musical notes repeating in each of the plurality of octaves. The apparatus is also caused to represent the sequence of musical notes as a set of colors, wherein each color of the set of colors is unique to each note in the sequence of musical notes, wherein the music notation comprises representing a musical note as a shape that is colored according to the set of colors, and wherein the shape is augmented with a modification of the set of colors, a symbol, or a combination thereof to indicate that the musical note is in the base octave, a lower octave than the base octave, or a higher octave than the base octave.

According to another embodiment, a computer-readable storage medium carries one or more sequences of one or more instructions which, when executed by one or more processors, cause, at least in part, an apparatus to designate a base octave of a musical note range comprising a plurality of octaves; wherein the base octave comprises a sequence of musical notes, the sequence of musical notes repeating in each of the plurality of octaves. The apparatus is also caused to represent the sequence of musical notes as a set of colors, wherein each color of the set of colors is unique to each note in the sequence of musical notes, wherein the music notation comprises representing a musical note as a shape that is colored according to the set of colors, and wherein the shape is augmented with a modification of the set of colors, a symbol, or a combination thereof to indicate that the musical note is in the base octave, a lower octave than the base octave, or a higher octave than the base octave.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: A system and/or apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of encoding musical information according to a music notation based on color, according to one example embodiment;

FIG. 2 is a diagram of the components of the notation platform 103, according to one example embodiment;

FIG. 3 is a flowchart of a process for encoding musical information according to a music notation based on color, according to one example embodiment;

FIG. 4 is a flowchart of a process for encoding a pitch or an octave of a musical note into a colored shape, according to one example embodiment;

FIG. 5 is a flowchart of a process for encoding a musical note duration or a rest duration into a shape and/or a symbol, according to one example embodiment;

FIG. 6 is a flowchart of a process for encoding a group of musical notes into a group of colored shapes and/or symbols, according to one example embodiment;

FIGS. 7A-7C are diagrams of musical information encoded according to a music notation based on colors using a piano keyboard as a reference, according to one example embodiment;

FIGS. 8A-8B are user interface diagrams utilized in the processes of FIGS. 3-6, according to one example embodiment;

FIG. 9 is an example of a painting including musical information encoded according to the processes of FIGS. 3-6, according to one example embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for encoding musical information according to a music notation based on color are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

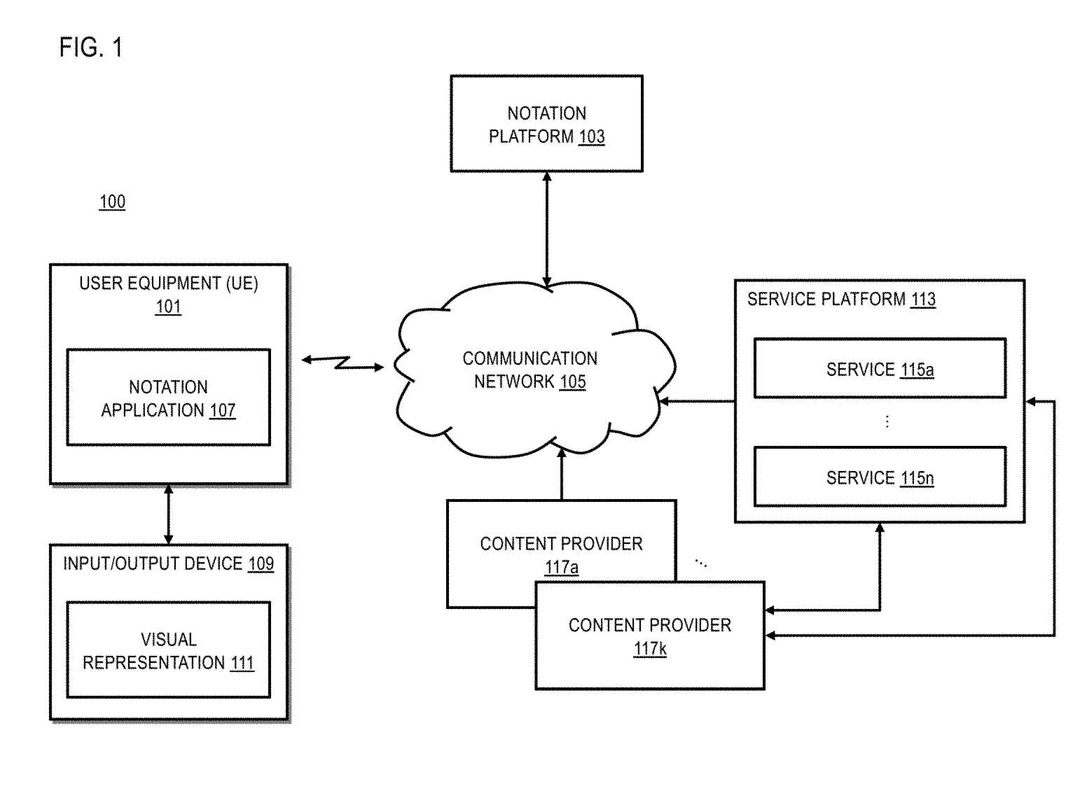

FIG. 1 is a diagram of a system capable of encoding musical information according to a music notation based on color, according to one embodiment. As noted above, reading conventional music notation correctly and without difficulty requires expertise in musical skills. An average or novice user may have trouble understanding music notation due to the counter-intuitive nature of the system. In addition, young users may have difficulty understanding music notation due to the complex nature of the notation structures. As a result, the system 100 encodes musical information according to a music notation based on color, which can coexist with other music notation systems (e.g., staff notation and numbered notation). Thus, making it easier for a user to read the notation and to play the music once they have learned the system. In addition, by assigning different colors to different pitches, the system 100 can assist users to memorize pitches and associated colors visually. It is contemplated that the system 100 can enhance a child's interest in learning music and color, linking a child's visual and auditory memory imagination. In one instance, the music notation described herein may be presented in connection with a piano keyboard. The piano is instructive in this regard because it has the widest sound range among all types of instruments and thus can explain the described music notation more directly. For example, different colors may be assigned to piano keys of different pitches so that the music pitch represented by each piano key corresponds to a different color block. In addition, the system 100 incorporates auxiliary symbols (e.g., a bar symbol below or above a color block) to represent distinctive pitches (e.g., bass and treble pitches). Further, the system 100 enables a user to perceive an isometric correspondence between the length of the color blocks and the duration of the music notes so that the overall music melody and rhythm can be performed.

To address these challenges, a system 100 of FIG. 1 introduces a capability to encode musical information (e.g., a musical composition) according to a music notation based on color. In one embodiment, the system 100 designates a base octave (i.e., an initial reference octave) of a musical note range (e.g., a piano note range) comprising a plurality of octaves, wherein the base octave (e.g., a one-lined octave) comprises a sequence of musical notes (e.g., C-D-E-F-G-A-B), and the sequence of musical notes repeats in each of the plurality of octaves. In one embodiment, the system 100 represents the sequence of musical notes as a set of colors (e.g., red, orange, yellow, green, cyan, blue, and purple), wherein each color of the set is unique to each note (e.g., the C note is represented as red, the D note is represented as orange, and so forth). In one embodiment, the set of colors is repeated for each octave of the musical note range (e.g., each C note of the range is represented as red). In one embodiment, the system 100 represents each musical note as a shape (e.g., a dashed frame cell or a box) that is colored according to the set of colors (e.g., red, orange, yellow, etc.). Although the shape is commonly described herein as a frame cell or a box, it is contemplated that the shape could be any geometric shape or visual representation.

A musical note range is wider than a single octave. As a result, in one embodiment, the system 100 augments the shape (e.g., a dashed frame cell) with a modification of the set of colors (e.g., darkening or lightening the color), a symbol (e.g., a bar symbol above or below the shape), or a combination thereof to indicate that a musical note is in the base octave, an octave lower than the base octave, or an octave higher than the base octave. In one embodiment, the system 100 renders the color of the octaves other than the base octave with a different intensity. In one instance, the system 100 renders the colors of the octave lower than the base octave a darker set of colors and renders the colors of the octave higher than the base octave a lighter set of colors.

In addition to modifying the set of colors to indicate the octave of a musical note relative to the base octave, the system 100 can also augment the shape with a symbol. In one embodiment, the system 100 renders a symbol (e.g., a bar or rectangle) relative to the shape to indicate that the musical note associated with the shape is an octave lower or higher than the corresponding musical note of the base octave. By way of example, the system 100 can represent a musical note of an octave lower than the base octave with a bar under the dashed frame cell and a musical note of a higher octave than the base octave with a bar above the dashed frame cell. In one instance, the system 100 renders the bar below the dashed frame cell as black and the bar above the dashed frame cell as white. It is contemplated that while the symbol is primarily described herein as being a bar or rectangle, the system 100 could augment the shape with any kind of symbol that would suggests an octave lower or higher than the base octave.

In addition to pitch, musical duration is an integral part of accurately reading and playing music. In one embodiment, the system 100 renders the shape (e.g., a dashed frame cell) [symbol] as a predetermined size, wherein the predetermined size represents a predetermined duration of the musical note or a rest (e.g., a quarter note or a quarter rest). In one instance, the musical note and the rest (i.e., rhythmic silence) are graphically differentiated by the system 100 by the fact that a musical note is rendered as a black dashed frame cell and the rest is rendered as a white dashed frame cell. Moreover, in one instance, the system 100 renders the rest shape with a symbol within the cell as follows: [symbol] . In one embodiment, the system 100 subdivides the shape (e.g., a dashed frame cell) into a plurality of sub-shapes (e.g., two dashed frame cells within the predetermined size of the quarter note) to indicate a musical notation duration or a rest duration less than the predetermined duration (e.g., as in two eighth notes or an eighth rest) and the system 100 concatenates the shape with one or more other shapes to indicate a musical note duration or a rest duration that is greater than the predetermined duration (e.g., as in half note or half rest). In instances where one or more musical notes are melodically grouped together (e.g., a slur), the system 100 can group the shape with at least one other shape representing a same or a different musical note using a symbol (e.g., a horizontal curved line). Similarly, in instances where one or more musical notes are harmonically grouped together (e.g., a solid chord), the system 100 can group the shape and at least one other shape representing a different musical note using a relative position of the shapes (e.g., a vertical stacking). By way of example, the system 100 can represent a group or measure of musical notes by rendering a one or more bar lines (e.g., a single line, a double line, or a double line with two dots) among a group of successive shapes.

As shown in FIG. 1, the system 100 comprises one or more user equipment (UE) 101 having connectivity to a notation platform 103, via a communication network 105. In one embodiment, the notation platform 103 performs one or more functions for encoding musical information into a music notation based on color as discussed with respect to the various embodiments described herein. In addition or alternatively, the UE 101 may execute a notation application 107 to perform one or more functions for encoding musical information into a colored music notation.

In one embodiment, the UE 101 further has connectivity to one or more input/output devices 109 for ingesting audio or visual data or for generating audio or visual data. For example, for ingesting audio or visual data, the input/output device 109 may include a microphone for sampling audio, or a camera or scanner for capturing visual data (e.g., sheet music) including visual representations 111 (e.g., a painting) generated according to the various embodiments described herein. It is contemplated that the input/output device 109 may be configured with any sensor suitable for sampling or capturing audio and/or visual data into digital format for processing by the system 100.

In one embodiment, the type of sensor configured can be based on the type of source data. For example, it is contemplated that audio data can include audio data presented in any form. If audio data is present in the form of musical notation in a song book, for instance, the input/output device 109 can use a scanning device or camera to capture images of the musical notation in the song book for encoding into audio data (e.g., data comprising musical tones or notes and their respective durations). The system 100 can then process the images to extract the audio data through image recognition techniques (e.g., optical character recognition (OCR)). In another example, if the audio data is audible data (e.g., live music or music played over speakers), the input/output device 109 can use a microphone to capture audio samples. The system 100 can then process the audio samples using audio recognition or other similar techniques to determine the tones or notes played and their respective durations.

In one embodiment, for outputting audio or visual data, the input/output device 109 can be configured with any number of suitable output modules. For example, to output visual data (e.g., images or other visual representations), the input/output device 109 may be configured with displays (e.g., monitors, projectors, televisions, etc.) to present visual representations 111. For example, a display can be mounted on a wall to present the converted audio data as an image (e.g., a color chart). In addition, the input/output device 109 may include devices for creating physical versions (e.g., paper, canvas, and/or other media such as wood, stone, etc.) of the visual representations 111. These devices include, but are not limited to, printers, three-dimensional printers, computerized numerical control (CNC) machines, printing presses, and the like. Similarly, to output audio data, the input/output device 109 can be configured with an audio playback system.

In one embodiment, the visual representations 111 can embody any electronic or physical form. For example, electronic forms can include images (e.g., a color chart or a painting including a color strip), videos, three-dimensional models, etc. Similarly, physical forms of the visual representations can be in any media or material including, but not limited, to wood, metal, clothes, fabric, collages, etc. of various colors or composition. In one embodiment, these physical forms can be directly generated through appropriate output devices (e.g., printers or other automated means). In another embodiment, the system 100 can provide an output listing of instructions (e.g., color selections, schematics, brush stroke suggestions, etc.) for a user to manually create the visual representation through an artistic medium (e.g., painting, sculpture, etc.). In yet another embodiment, it is contemplated that the visual representation can be imprinted on or otherwise depicted on any article of manufacture including, but not limited, to clothes or other products (e.g., souvenirs, etc.) composed of any material or medium.

In one embodiment, the input/output device 109 can include a piano keyboard or other similar instrument configured with lighting of different colors (e.g., multi-color LED lighting) that is fixed onto the keyboard. In this way, the keyboard can display appropriate colors corresponding to the notes of the keys to help a user learn the corresponding pitch of each color, which can then lead to the reflection of the corresponding pitch in the cognitive system of the user.

In one embodiment, the input/output device 109 can include a “reading pen” that is configured with a sensor module capable of reading color values. For example, a user may move the reading pen 109 across a chart of colored shapes or a color strip of a painting. In this way, a user can hear the sound or pitch of a colored shape (e.g., a red or blue dashed frame cell) to remind the user of the corresponding sound or pitch or to reinforce his or her comprehension of the learned notation (e.g., lighter colors represent higher pitches). The colors that are read by the reading pen 109 are then encoded into audio data using the processes discussed with respect to the various embodiments described herein.

In one embodiment, the UE 101 and/or the notation platform 103 also have connectivity to a service platform 113 that includes one or more services 115a-115n (also collectivity referred to as services 115) for providing other media services and/or other services that support the notation platform 103 (e.g., music, images, cloud storage, printing, content, etc. services). In one embodiment, the service platform 113 and/or services 115 interact with one or more content providers 117a-117k (also collectively referred to as content providers 117) to provide media or artistic information and/or other related information to the notation platform 103.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a navigation unit (e.g., in-vehicle or standalone), a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the notation platform 103, and the notation application 107 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effectuated by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the notation application 107 and the notation platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

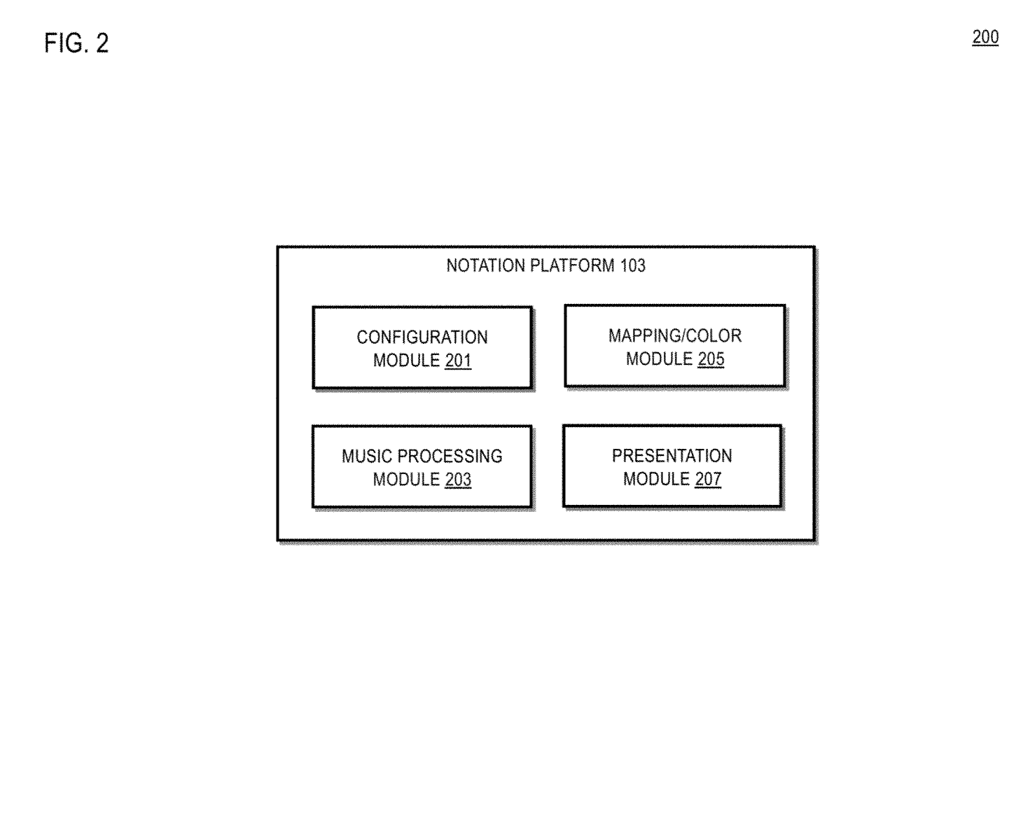

FIG. 2 is a diagram of the components of the notation platform 103, according to one example embodiment. By way of example, the notation platform 103 includes one or more components for encoding musical information according to a music notation based on color. It is contemplated that the functions of these components may be combined in one or more components or performed by other components of equivalent functionality. In one embodiment, the notation platform 103 comprises a configuration module 201, a music processing module 203, a mapping/color module 205, and a presentation module 207, or any combination thereof.

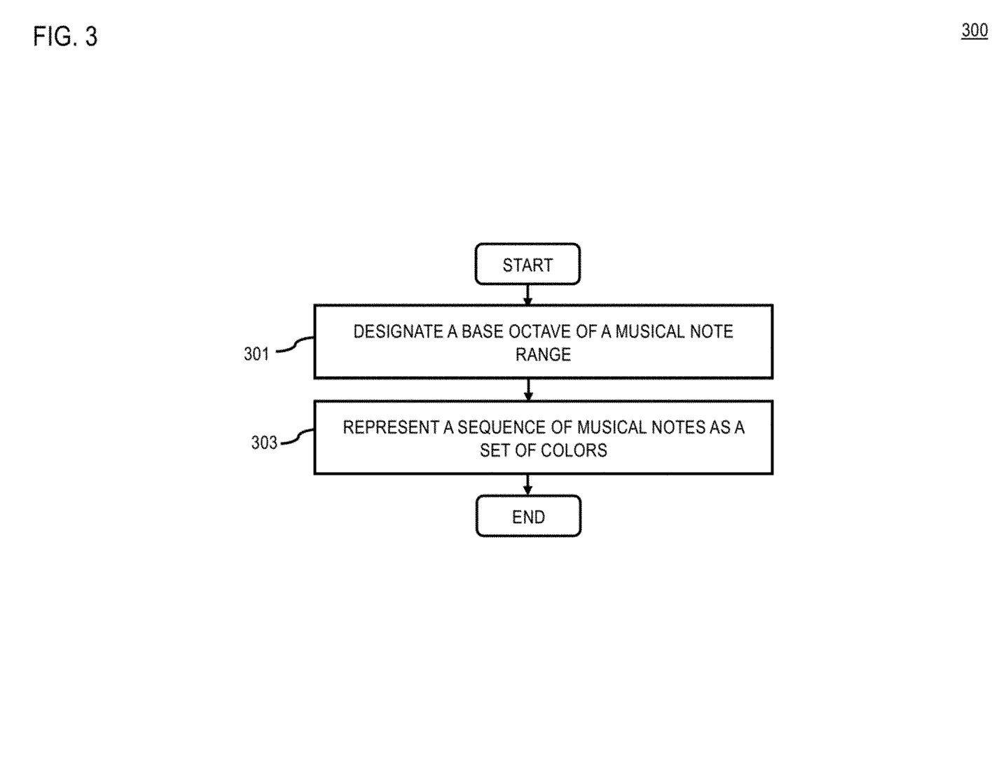

The above presented modules and components of the notation platform 103 can be implemented in hardware, firmware, software, or a combination thereof. Though depicted as a separate entity in FIG. 1, it is contemplated that the notation platform 103 may be implemented for direct operation by respective UE 101. As such, the notation platform 103 may generate direct signal inputs by way of the operating system of the UE 101 for interacting with the notation application 107. In another embodiment, one or more of the modules 201-207 may be implemented for operation by respective UEs 101, as the notation platform 103, or combination thereof. Still further, the notation platform 103 may be integrated for direct operation with the services 115, such as in the form of a widget or applet, in accordance with an information and/or subscriber sharing arrangement. The various executions presented herein contemplate any and all arrangements and models. In another embodiment, the notation platform 103 and/or one or more of the modules 201-207 may be implemented as a cloud-based service, local service, native application, or combination thereof. The functions of the notation platform 103 and the modules 201-207 are discussed with respect to FIGS. 3-6 below.

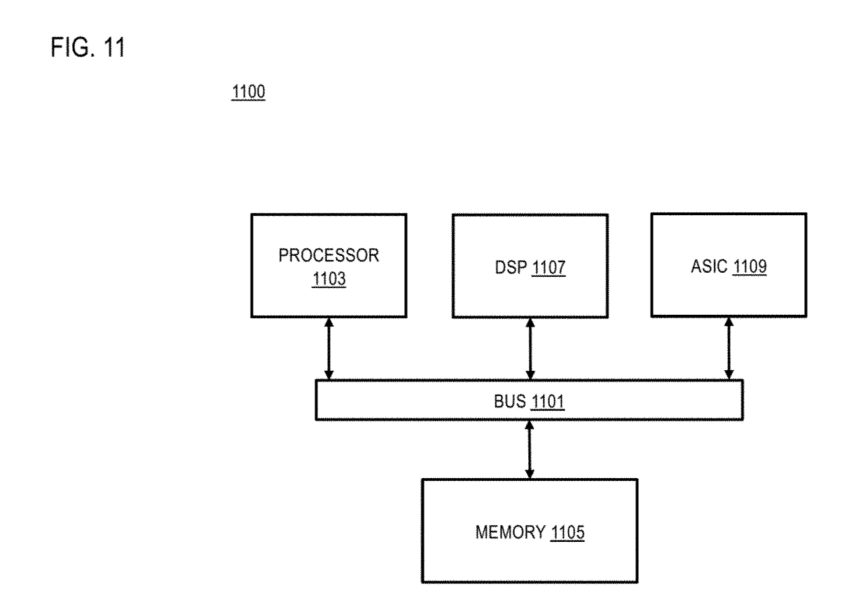

FIG. 3 is a flowchart of a process for encoding musical information according to a music notation based on color, according to one example embodiment. In various embodiments, the notation platform 103 and/or the modules 201-207 of the notation platform 103 as shown in FIG. 2 may perform one or more portions of the process 300 and may be implemented in, for instance, a chip set including a processor and a memory as shown in FIG. 11. As such, the notation platform 103 and/or the modules 201-207 can provide means for accomplishing various parts of the process 300, as well as means for accomplishing embodiments of other processes described herein in conjunction with other components of the system 100. Although the process 300 is illustrated and described as a sequence of steps, it is contemplated that various embodiments of the process 300 may be performed in any order or combination and need not include all of the illustrated steps.

In step 301, the configuration module 201, in connection with the music processing module 203, designates a base octave of a musical note range comprising a plurality of octaves, wherein the base octave comprises a sequence of musical notes (e.g., C-D-E-F-G-A-B), the sequence of musical notes repeating in each of the plurality of octaves (e.g., octaves of the low-pitched range, mid-pitched range, and high-pitched range). In one embodiment, the configuration module 201 designates the base octave by first determining the applicable music note range based on an input (e.g., a sheet music or an audio clip via the music processing module 203). By way of example, the music processing module 203 may use one or more OCR techniques to scan a music sheet and to determine the music notes associated with a song (e.g., Beethoven's Joy). As discussed above, it may be difficult for a novice or a young user to read a sheet music to sing the corresponding song. Thus, in one instance, the configuration module 201 designates a base octave (i.e., a reference octave or a starting point) to start encoding the musical information associated with the sheet music and/or the song to assist the user to play the music. It is contemplated that the music processing module 203 could determine the applicable music note range visually, audibly (e.g., via a microphone), or a combination thereof. It is also contemplated that the configuration module 201 could designate any octave within the applicable musical range as the base octave since the base octave has no inherent audio or musical characteristics or properties. In one instance, the configuration module 201 may designate the one-lined octave of the piano note range (if applicable) as the base octave since the one-lined octave includes the note middle C and in the case of the modern piano with 88 keys there are two octaves lower in pitch than the one-line octave and two octaves that are higher in pitch than the one-lined octave. In some instances, the seven octaves of the piano are alphanumerically designated as C1-B1, C2-B2, C3-B3, C4-B4, C5-B5, C6-B6, and C7-B7, wherein C4 is the note middle C.

In step 303, the mapping/color module 205 and the presentation module 207 represent the sequence of musical notes as a set of colors, wherein each color of the set of colors is unique to each note in the sequence of musical notes, wherein the music notation comprises representing a musical note as a shape that is colored according to the set of colors, and wherein the shape is augmented with a modification of the set of colors, a symbol, or a combination thereof to indicate that the musical note is in the base octave, a lower octave than the base octave, or a higher octave than the base octave. In one embodiment, as described more fully below with respect to process 400, the pitch or sound of each musical note is encoded by the notation platform 103 according to a color. In one instance, the mapping/color module 205 maps each color of the set of colors (e.g., red, orange, yellow, green, cyan, blue, and purple) to each note in the sequence of musical notes (C-D-E-F-G-A-B) such that the user can quickly appreciate the different pitches and sounds of a song that the user is trying to sing or play. By way of example, the mapping/color module 205 may map the example colors red, orange, yellow, green, cyan, blue, and purple to the sequence of notes of the base octave such that the C note (lowest in pitch) is represented as red, the D note is represented as orange, the E note is represented as yellow, the F note is represented as green, the G note is represented as cyan, the A note is represented as blue, and the B note (highest in pitch) is represented as purple. In this example, once a user learned the notation system, the user could read or sing the sequence of colors of the base octave as “do-re-me-fa-so-la-si.”

In one embodiment, as described more fully below with respect to the processes 400 and 500, the duration of each musical note is encoded by the notation platform 103 according to one or more shapes. By way of example, the configuration module 201 can determine to encode a quarter note as a dashed frame cell or box. The music processing module 203 may also determine that the quarter note is a C note in terms of pitch. Thereafter, the mapping/color module 205 can map the color red, for example, to the shape so that when the presentation module 207 presents the colored shape to a user, the user can read or sing the note as “do” for one beat. It is contemplated that the configuration module 201 can encode each musical note as any geometric shape or visual representation capable of being colored by the set of colors.

In one embodiment, as described more fully below with respect to the processes 400, the notation platform 103 augments each shape with a modification of the set of colors (e.g., dark red, medium red, light red), a symbol (e.g., a light or dark bar or rectangle), or a combination thereof to enable a user to quickly determine whether the musical note is in the base octave or in an octave lower or higher than the base octave. Following the example described above, the user can read or sing the note as “do” for one beat; however, at this stage, he or she may not know whether the C note is in the base octave (e.g., one-lined octave), a lower octave (e.g., unaccented octave) or a higher octave (e.g., two-lined octave) than the base octave and, therefore, may not properly read or play the note.

In one embodiment, the mapping/color module 205 map the colors red, orange, yellow, green, cyan, blue, and purple to the musical notes of the base octave (e.g., C4-D4-E4-F4-G4-A4-B4) and modifies the set of colors by mapping a lightened version of the color set to the musical notes in an octave higher than the base octave (e.g., C5-D5-E5-F5-G5-A5-B5) and by mapping a darkened version of the color set to the musical notes in an octave lower than the base octave (e.g., C3-D3-E3-F3-G3-A3-B3). In this instance, a user could quickly discern that a sequence of a dark red shape, a medium red shape, and a light red shape presented by the presentation module 207 indicates an ascending sequence of C notes to be read or sang “do-do-do.” In this example, the notation platform 103 can only encode 21 unique notes (assuming seven notes per octave); however, in many instances, the music processing module 203 may determine that musical information of a song includes one or more musical notes outside of this range (e.g., in a higher or lower range of octaves). In one embodiment, the configuration module 201 augments the shape (e.g., a dashed frame cell or box) with a symbol (e.g., a bar) to indicate whether a musical note is an octave below or above the base octave. By way of example, the configuration module 201 may augment the shape with a black bar or rectangle below the shape for a note in lower range of octaves (e.g., bass) and with a white bar or rectangle above the shape for a note in a higher range of octaves (e.g., treble). Consequently, a user can now quickly read or sing the shapes/symbols according to the corresponding pitch.

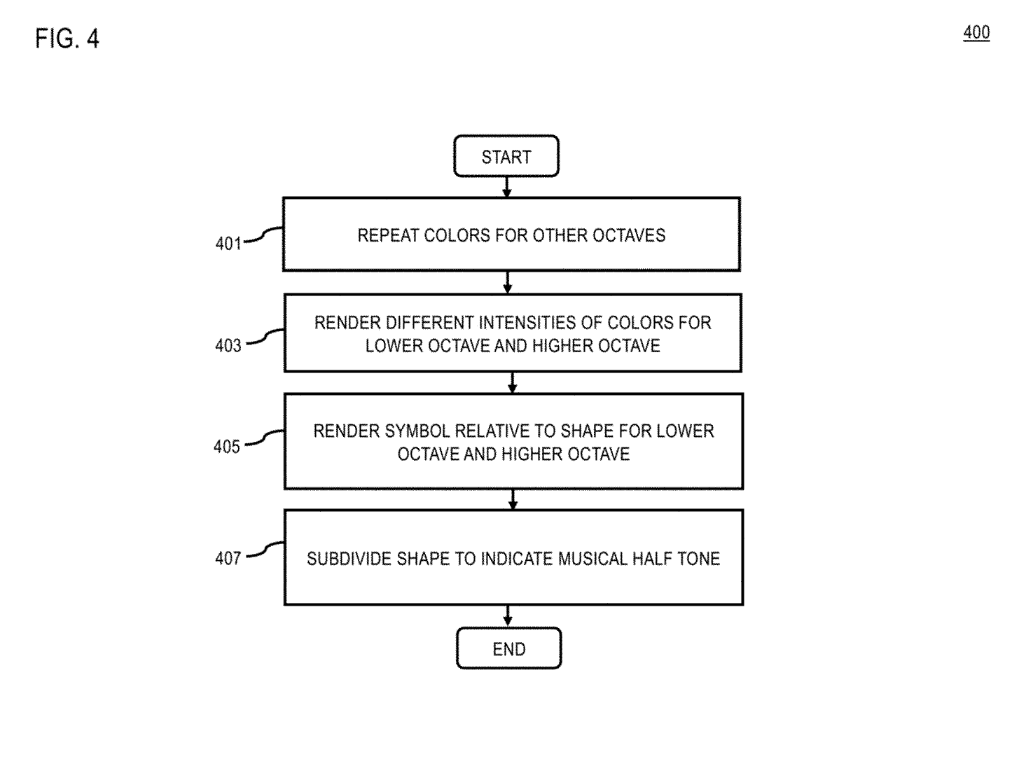

FIG. 4 is a flowchart of a process for encoding a pitch or an octave of a musical note into a colored shape, according to one example embodiment. In various embodiments, the notation platform 103 and/or the modules 201-207 of the notation platform 103 as shown in FIG. 2 may perform one or more portions of the process 400 and may be implemented in, for instance, a chip set including a processor and a memory as shown in FIG. 11. As such, the notation platform 103 and/or the modules 201-207 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In step 401, the mapping/color module 205 repeats the set of colors for other octaves of the plurality of octaves. As described above, once the configuration module 201 designates a base octave of the musical note range (e.g., a piano note range) of musical information (e.g., a song such as Beethoven's Joy), the mapping/color module 205 represents the sequence of the musical notes as a set of colors. Following the example described above, the mapping/color module 205 maps the sequence of notes of the base octave as red, orange, yellow, green, cyan, blue, and purple. The mapping module 205 then repeats the mapped colors for each other octave of the musical note range. For example, each C note of the modern piano note range (e.g., C1-C7) are rendered in a color red, each D note (e.g., D1-D7) is rendered in a color orange, and so forth following the example described above. However, at this stage, a user would only know that a red shape represented the C note and would not know the corresponding octave for each C note.

In step 403, the configuration module 201, in connection with the mapping/color module 205, renders the set of colors (e.g., red, orange, yellow, green, cyan, blue, and purple) a different intensity for the octaves other than the base octave. Following the example above, the mapping/color module 205 first renders the musical notes of the base octave (e.g., the one-lined octave) the set of colors. In one embodiment, the mapping/color module 205 renders the musical notes of octave lower than the base octave a darker set of colors and the octave higher than the base octave a lighter set of colors. Thus, in this instance, the mapping/color module 205 renders the musical notes of the lower octave (e.g., the unaccented octave) dark red through dark purple and the mapping/color module 205 renders the musical notes of the higher octave (e.g., the two-lined octave) light red through light purple. The configuration module 201 then adjusts the musical notes of the higher and lower ranges accordingly such that the low-pitched range of the 88 key piano starts at deep red and ends with purple (C1-B2) and the high-pitched range of the 88 key piano starts with deep red and ends with purple (C6-B7). However, at this stage, while a user may be able to organize one or more musical notes in ascending or descending order in terms of pitch, he or she would not know within which range each C note fell.

In step 405, configuration module 201 augments the shape by rendering the symbol (e.g., a bar or rectangle) at a first position with respect to the shape to indicate the lower octave and at a second position with respect to the shape to indicate the higher octave. By way of example, the configuration module 201 may determine to represent the symbol as a dashed bar or rectangle; however, it is contemplated that the configuration module 201 could determine to represent the symbol as any shape or symbol to indicate a lower or a higher octave. For instance, if the configuration module 201 represented a musical note as a circular shape, the configuration module 201 may render a circular symbol relative to the circular shape or the configuration module 201 could render the symbol as an unrelated shape (e.g., a triangle or star). Similarly, the configuration module 201 could render the symbol as an up arrow for octaves higher than the base octave and as a down arrow for octaves lower than the base octave. In one instance, the first position is below the shape and the second position is above the shape; however, in the example of the arrow, the first position and the second position may be the same position. Following the example wherein the mapping/color module 205 maps the color red to the C note of the one-lined octave (C4), dark red to the C note of unaccented octave (C3), and light red to the C note of the two-lined octave (C5), the configuration module 201 can augment each of these shapes with a symbol above or below the shape to indicate the appropriate octave and/or range. For example, the presentation module 207 can render the notes C1-C7 as follows: dark red with a black bar below the shape, medium red with a black bar below the shape, dark red, medium red, light red, dark red with a white bar above the shape, and red with a white bar above the shape. Consequently, a user would now be able to know the pitch and octave of each encoded musical note such that he or she would know whether two sequences of “do-re-mi” sounded alike or ascended or descend in octaves.

In step 407, the configuration module 201 subdivides the shape into sub-shapes to indicate a musical half tone. By way of example, a sharp sign or a flat sign indicates that the user is to play or sing the nearest key to the right or the left of the music note. For example, a D note is played for a C sharp and a C note is played for a D flat. In one instance, the music processing module 203 and the presentation module 207 can encode musical half tones such as a sharp sign or a flat sign as follows: [symbol] . Using the example colors from above, the mapping/color module 205 would replace the letter “C” with the color red and the letter “D” with the color orange and the intensity of the colors would depend on the corresponding octave of the musical notes. Further, if the musical notes are in the low-pitched or high-pitched ranges, the configuration module 103 may augment the shape with a black bar below or a white bar above, for example. As such, the notation platform 201 can encode enharmonic notes (i.e., notes that are written differently such as A flat and G sharp, but that sound the same in the tempered scale).

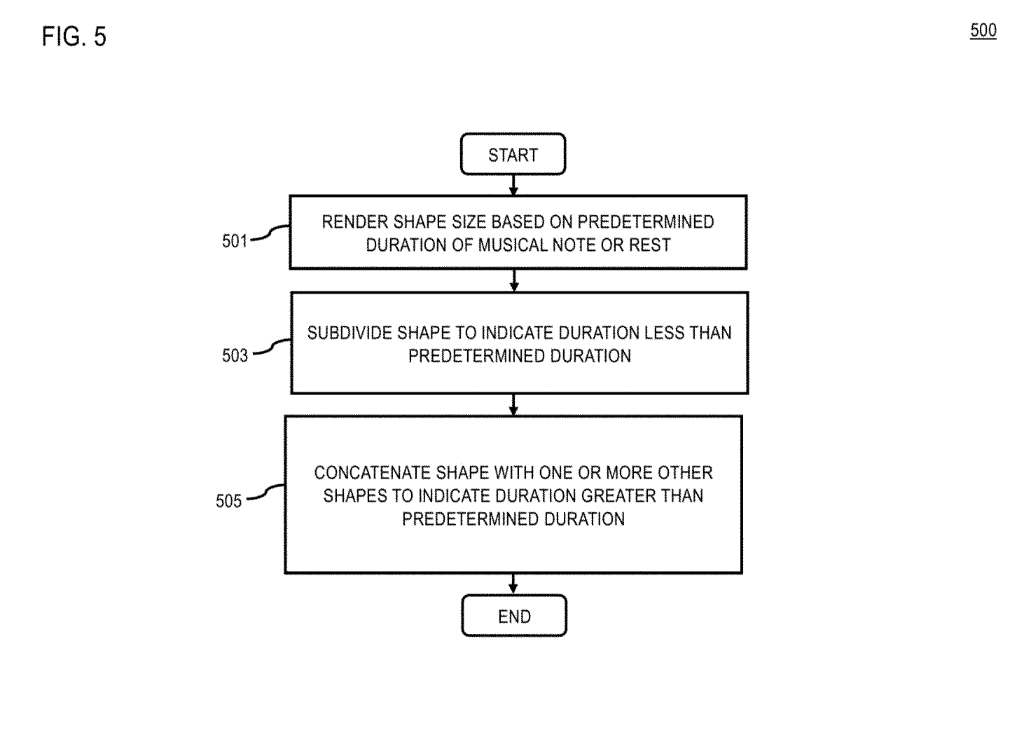

FIG. 5 is a flowchart of a process for encoding a musical note duration or a rest duration into a shape and/or a symbol, according to one example embodiment. In various embodiments, the notation platform 103 and/or the modules 201-207 of the notation platform 103 as shown in FIG. 2 may perform one or more portions of the process 500 and may be implemented in, for instance, a chip set including a processor and a memory as shown in FIG. 11. As such, the notation platform 103 and/or the modules 201-207 can provide means for accomplishing various parts of the process 500, as well as means for accomplishing embodiments of other processes described herein in conjunction with other components of the system 100. Although the process 500 is illustrated and described as a sequence of steps, it is contemplated that various embodiments of the process 500 may be performed in any order or combination and need not include all of the illustrated steps.

In step 501, the configuration module 201, in connection with the music processing module 203 and the presentation module 207, causes the shape (e.g., a dashed frame cell or box) to be rendered at a predetermined size, wherein the predetermined size represents a predetermined duration of the musical note or a rest. In one instance, as described above, the predetermined size may represent a quarter note (i.e., sang or played for one beat) and a quarter rest (i.e., a rest or rhythmic silence for one beat). In the instance where the configuration module 201 determines that the shape is a dashed frame cell, the presentation module 207 may represent the quarter note as follows: [symbol] and may represent the quarter rest as follows: [symbol] . More specifically, in one instance, the presentation module 207 may represent the quarter note as a black dashed frame cell or box encompassing a mapped color (e.g., red, orange, yellow, etc.) depending on the note and the presentation module 207 may represent the quarter rest as a white dashed frame cell or box encompassing a rest symbol with no mapped color since the rest sign represents a rhythmic silence. Again, it is contemplated that the shape could be any geometric shape or visual representation that can encompass a color and it is contemplated that the rest symbol could encompass any symbol.

In step 503, the configuration module 201 subdivides the shape (e.g., a dashed frame cell or box) into a plurality of sub-shapes (e.g., a dashed framed cell split with a dashed vertical line) to indicate a musical note duration or a rest duration less than the predetermined duration (e.g., as in two eighths notes or a half a beat). In the example described above, wherein the configuration module 201 determines the predetermined size of the quarter note is [symbol] , for example, the music processing module 203 and the presentation module 207 may encode the musical notes of a song, for example, with a duration less than the determined duration such as two eighths notes (i.e., play or sing for half a beat) and a one third note (i.e., play or sing for ⅓ of a beat) as follows: [symbol] and [symbol] , respectively. In one instance, the mapping/color module 205 may map the two eighths notes with a proportion of the color to represent the time length (i.e., half a beat). Alternatively, the configuration module 201 may split the quarter note into two or three segments as shown with respect to the one third note above. Similarly, the music processing module 203 and the presentation module 207 may encode a rest sign with a duration less than the determined duration such as eighth rest (i.e., rest for half a beat) as follows: [symbol] . Again, the mapping/color module 205 may only map the eighth rest with a proportion of color to represent the time length (i.e., a half rest). In these examples, the shape determined by the configuration module 201 (e.g., a dashed frame cell) is subdivide into a plurality of the same sub-shapes (e.g., dashed frame cells); however, it is contemplated that the sub-shapes may comprise any geometric shapes. The music processing module 203 and the presentation module 207 may also encode a musical note that is to be played with so short a duration that the tones are bound to be divided (i.e., staccato notes) with a symbol (e.g., a dot) above each shape as follows: [symbol] . In this instance, a dotted quarter note is to be played or sang the same as an eighth note (i.e., the dot cuts the duration of the note in half).

In step 505, the configuration module 201 concatenates the shape with one or more other shapes (e.g., multiple dashed frame cells) to indicate a musical note duration or a rest duration greater than the predetermined duration (e.g., a half note or half rest). Following the example described above, the music processing module 203 and the presentation module 207 may encode the musical notes of a song, for example, with a duration greater than the predetermined duration such as the half note, one and a half note, and whole note by concatenating the shape with one or more other shapes as follows: [symbol] , [symbol] , and [symbol] , respectively. Similarly, the music processing module 203 and the presentation module 207 may encode a rest sign with a duration greater than the determined duration such as a half rest and a whole rest (i.e., rest for four beats or the whole measure) as follows: [symbol] and [symbol] , respectively. In these examples, the configuration module 201 concatenates the shape (e.g., a dashed frame cell) with one or more other dashed frame cells for ease of reading and simplicity; however, it is contemplated that the one or more other shapes could be any geometric shapes.

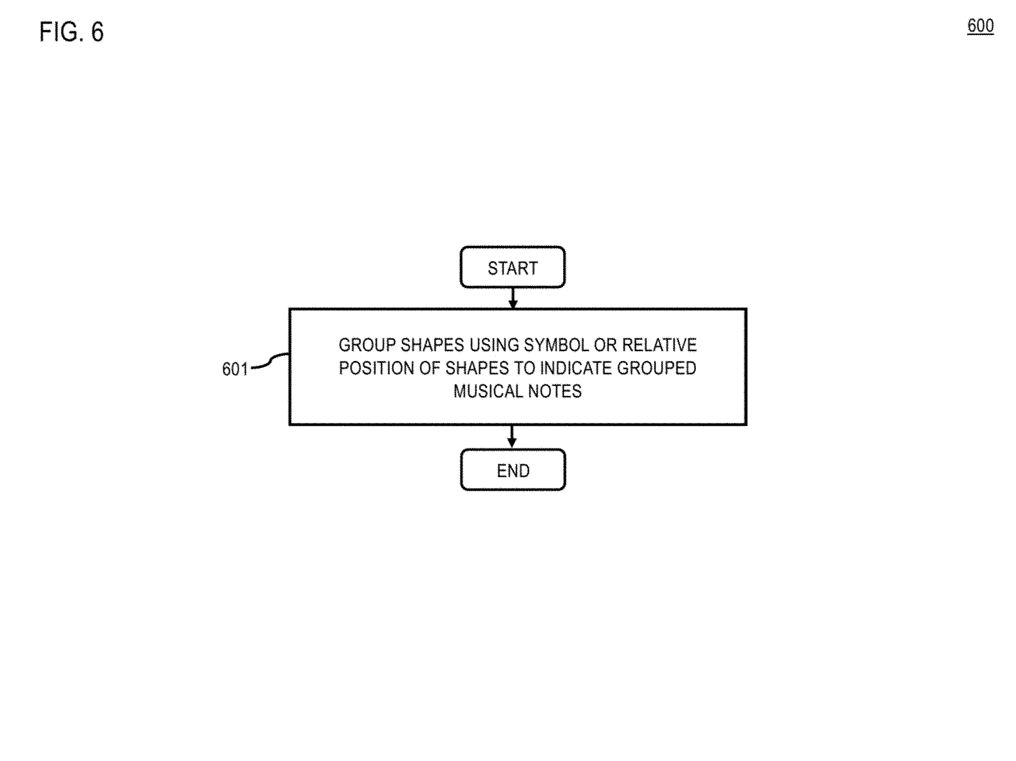

FIG. 6 is a flowchart of a process for encoding a group of musical notes into a group of colored shapes and/or symbols, according to one example embodiment. In various embodiments, the notation platform 103 and/or the modules 201-207 of the notation platform 103 as shown in FIG. 2 may perform one or more portions of the process 600 and may be implemented in, for instance, a chip set including a processor and a memory as shown in FIG. 11. As such, the notation platform 103 and/or the modules 201-207 can provide means for accomplishing various parts of the process 600, as well as means for accomplishing embodiments of other processes described herein in conjunction with other components of the system 100. Although the process 600 is illustrated and described as a sequence of steps, it is contemplated that various embodiments of the process 600 may be performed in any order or combination and need not include all of the illustrated steps.

In step 601, the configuration module 201 groups the shape with at least one other shape representing at least one other musical note using another symbol or a relative position of the shape to the at least one shape. Many music notes of a song (e.g., Beethoven's Joy) are organized together (e.g., as measures) or are intended to be played/sang together (e.g., as melodic intervals and harmonic intervals). Such groups may be encoded by the notation platform 201 through the incorporation of conventional music notation with the shapes and colors described herein. By way of example, the musical information of a song may be divided into measures as indicated by one or more bar lines. In one instance, the music processing module 203 and the presentation module 207 can encode the one or more bar lines of a song (e.g., via sheet music) into the colored music notation by incorporating such lines into the corresponding sequences of shapes. In another example, musical information of a song may be organized or divided according to musical dynamics which are expressed by the volume the music is to be played. By way of example, the symbol 7″ (standing for “forte” in Italian) below one or more musical notes indicates that the notes are to be played loudly. In contrast, the symbol “p” (standing for “piano” in Italian) indicates that the notes are to be softly. Like the bar lines, in one instance, the music processing module 203 and the presentation module 207 can encode one or more dynamic letters into the corresponding sequence of shapes as follows: [symbol] .

Examples of successive musical notes (e.g., a melodic interval) that are intended to be played together include slurs, ties, and the grand staff. By way of example, a slur connects two or more notes of different pitches together by a curved line over or under the musical notes. The notes contained in the slur should be played or sang legato (i.e., in a manner that is smooth and flowing). In one instance, the music processing module 203 and the presentation module 207 can encode a slur as follows: [symbol] . In the example shown, it should be noted that the mapping/color module 205 would map different colors to at least two of the shapes covered by the curved line. In contrast, a tie is a curved line that joins two musical notes of the same pitch to denote a single tone sustained the duration of the two notes. The music processing module 203 and the presentation module 207 can encode a tie, for instance, as follows: [symbol] . In this example, the user should only play one tone (e.g., the tone of the color shapes), but keep the double time of that color. Further, a grand staff is made by combining two staves, the upper (played by the right hand) and the lower (played by the left hand) with an accolade or brace (sometimes called a “curly brace”) and vertical bar lines. In one instance, the music processing module 203 and the presentation module 207 can encode a grand staff as follows: [symbol] . In one embodiment, the mapping/color module 205 maps one or more colors to the shapes to indicate the musical note or pitch of each shape. Then, the musical notes represented by the shapes/colors on the upper stave are to be played (or plucked, or strummed) with the right hand and the musical notes/colors represented by the shapes on the lower stave are to be played (or plucked, or strummed) with the left hand. Thus, the notation platform 103 can encode slurs, ties, and the grand staff according to the colored music notation by incorporating the conventional symbols (e.g., a horizontal or vertical curved line) with the shapes and colors described herein.

Examples of music notes that are intended to be sounded simultaneously include the harmonic interval and solid chords (e.g., the C chord). Unlike the successive music notes described above, the music notes that are intended to be sounded simultaneously are conventionally represented in a vertical orientation. By way of example, a harmonic interval is composed of two simultaneous sounds and this constitutes harmony in the music. In one embodiment, the music processing module 203 and the presentation module 207 can encode a harmonic interval as follows: [symbol] Following the example color set described above, in one instance, the mapping/color module 205 would replace the letter “D” with the color orange, the letter “C” with the color red, the letter “E” with the color yellow, and the letter “F” with the color green. Again, the intensity of the color would depend on the corresponding octave of the musical notes. Further, if the musical notes are in the low-pitched or high-pitched ranges, the configuration module 201 may augment the shape with a black bar below or a white bar above the shape, for example. Consequently, a user could read and play or sing the D and C notes simultaneously, the E and C notes simultaneously, etc. The solid chord is composed of three notes that are played simultaneously (e.g., C-E-G). The three sounds that compose the chord are called the root, the third, and the fifth, respectively. The notes are traditionally represented in vertical relationship to one another. Further, the chord is named by the lowest musical tone in the “stack.” For example, a chord started with the C note would be called a C chord. In one instance, the music processing module 203 and the presentation module 207 can encode a solid chord (e.g., a C chord) as follows: [symbol] . As discussed above, it is contemplated that the mapping/color module 205 would replace the letters with the corresponding colors and the configuration module 201 may augment the shapes (if necessary) by modifying the set of colors or rendering a different intensity of the colors.

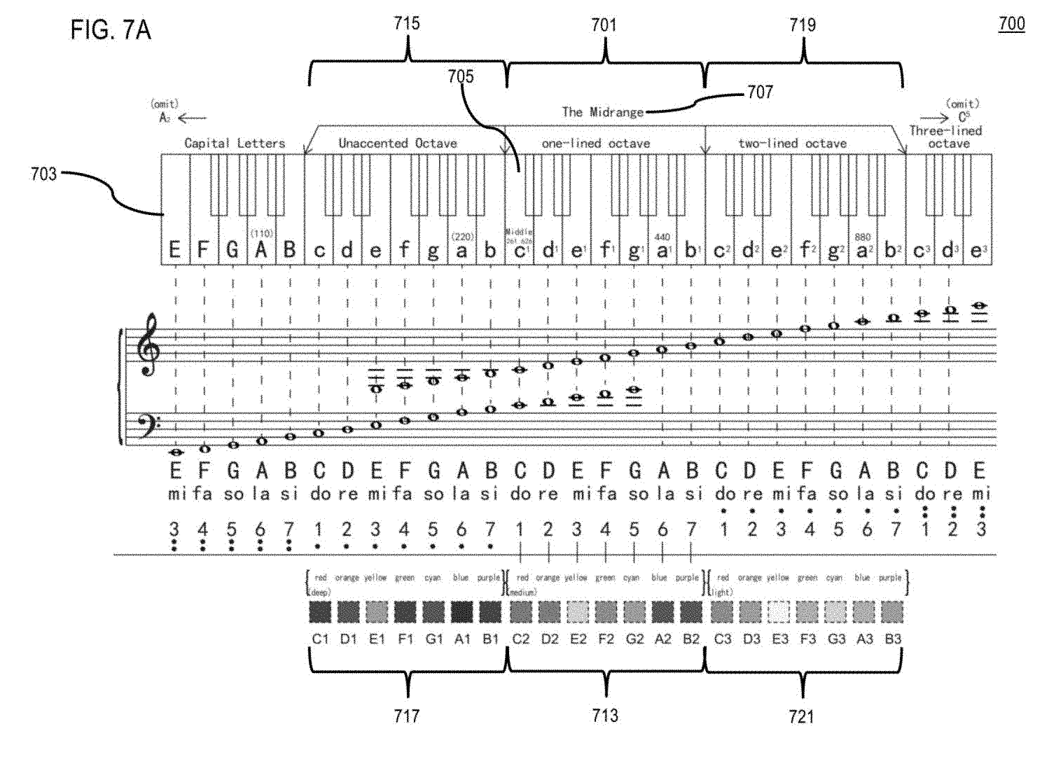

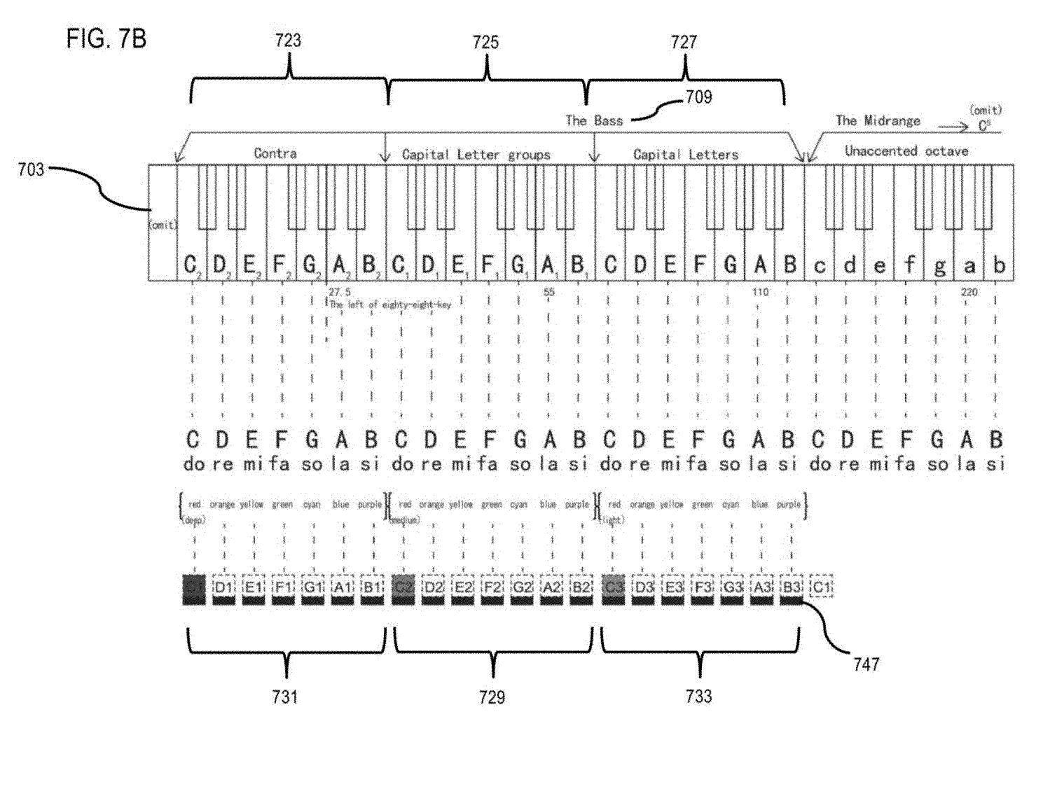

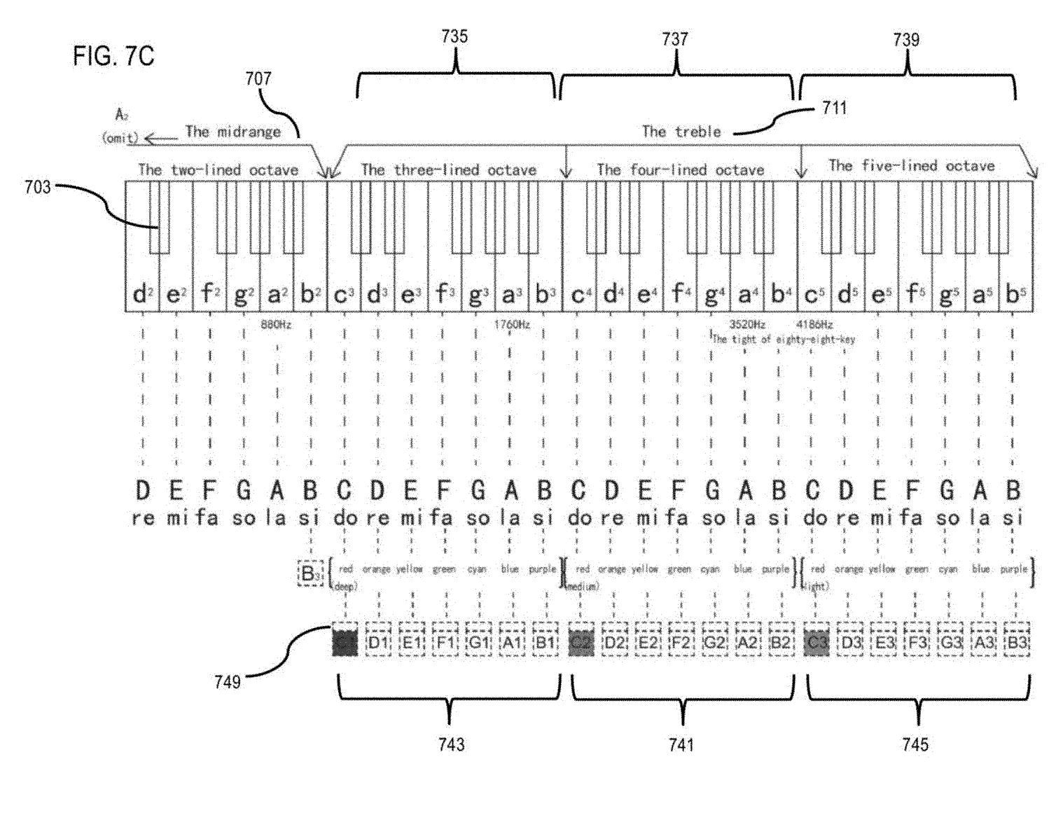

FIGS. 7A-7C are diagrams of musical information encoded according to a music notation based on colors using a piano keyboard as a reference, according to one example embodiment. As discussed above, novice users and particularly young users have difficulty reading music notation. However, by assigning different colors to different pitches, the system 100 can assist such users to memorize pitches and associated colors visually. In this instance, the system 100 designates the one-lined octave 701 of the musical note range of the piano 703 as the base octave (i.e., the reference or starting octave). As shown in FIGS. 7A-7C, the one-lined octave 701 includes the note middle C 705 and is part of the mid-pitched range of octaves (i.e., the midrange 707). In this example, there are three octaves that are in a range lower in pitch than the midrange 707 (i.e., the bass 709)(FIG. 7B) and three octaves that are higher in pitch than the midrange 707 (i.e., the treble 711)(FIG. 7C). As shown, each octave of the piano 703 is comprised of a sequence of musical notes (e.g., C-D-E-F-G-A-B), which are repeated throughout. As described above, the example of a piano is instructive because it has the widest sound range among all types of instruments and thus can explain the system 100's encoding of musical information according to a music notation based on color more directly relative to other instruments.

In one embodiment, the system 100 represents the sequence of musical notes of the base octave (e.g., C2-D2-E2-F2-G2-A2-B2) as the colors medium red, medium orange, medium yellow, medium green, medium cyan, medium blue, and medium purple, respectively, as depicted in the color blocks 713. In this instance, the system 100 renders each shape of the color blocks 713 (e.g., a black dashed frame cell or box) at a predetermined size based on a predetermined duration of the musical note (e.g., a quarter note played for one beat). The system 100 then repeats, in one instance, the set of colors for each octave of the piano 703. For example, in this instance, the system 100 renders each C note in the color red or a shade or intensity of red, each D note in the color orange or a shade or intensity of orange, and so forth. More specifically, in this example, once the system 100 represents the sequence of musical notes of the base octave as a set of colors as shown by the color blocks 713, the system 100 modifies the intensity of the set of colors for the musical notes of the octave lower than the base octave (i.e., the unaccented octave 715) by darkening the set of colors as depicted by the colors blocks 717. Similarly, the system 100 modifies the intensity of the set of colors for the musical notes of the octave higher than the base octave (i.e., the two-lined octave 719) by lightening the set of colors as depicted by the color blocks 721. It is contemplated that the differentiation of the colors will enable a novice user or a young child to quickly differentiate between notes and pitches of the notes. Thus, in this instance, the system 100 renders the musical notes of the unaccented octave 715 dark red through dark purple and the musical notes of the two-lined octave 719 light right through light purple.

In one embodiment, the system 100 repeats the mapped sequence of color blocks 717, 713, and 721 for the contra octave 723, the capital letters group octave 725, and the capital letters octave 727, respectively, as depicted by the color blocks 731, 729, and 733. Likewise, the system 100 repeats the mapped sequence of color blocks 717, 713, and 721 for the three-lined octave 735, the four-lined octave 737, and the five-lined octave 739, respectively, as depicted by the color blocks 743, 741, and 745. However, at this stage, a user would not be able to differentiate a C note of the contra octave 723, a C note of the unaccented octave 715, and a C note of the three-lined octave 729 as each of these notes is represented by the system 100 as dark red.

In one embodiment, the system 100 augments the shapes of the color blocks 729-733 by rendering a black bar or rectangle 747 under each shape to indicate that the octaves are lower than the octaves of the midrange 707 (i.e., octaves of the bass range 709). Similarly, the system 100 augments the shapes of the color blocks 741-745 by rendering a white bar or rectangle 749 above each shape to indicate that the octaves are higher than the octaves of the midrange 707 (i.e., octaves of the treble range 711). Consequently, a user could now correctly read each group of color blocks (e.g., color block 713) or individual shape (e.g., C2 of the one-lined octave 701) and would be able to sing or play the corresponding pitch.

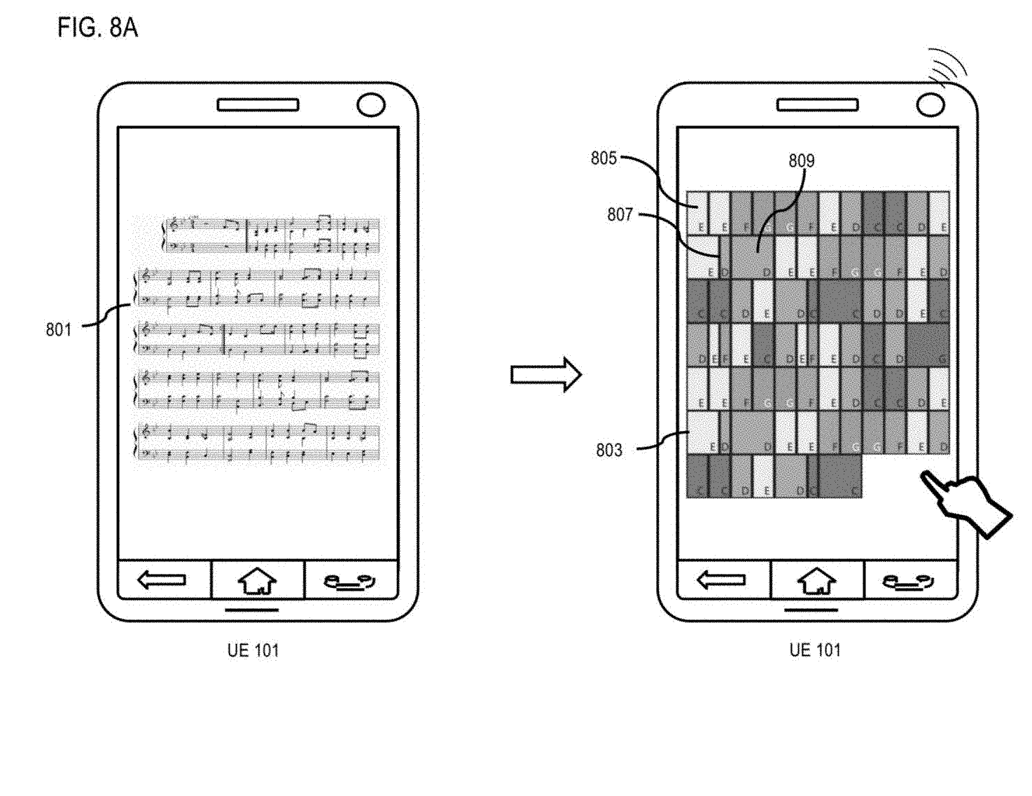

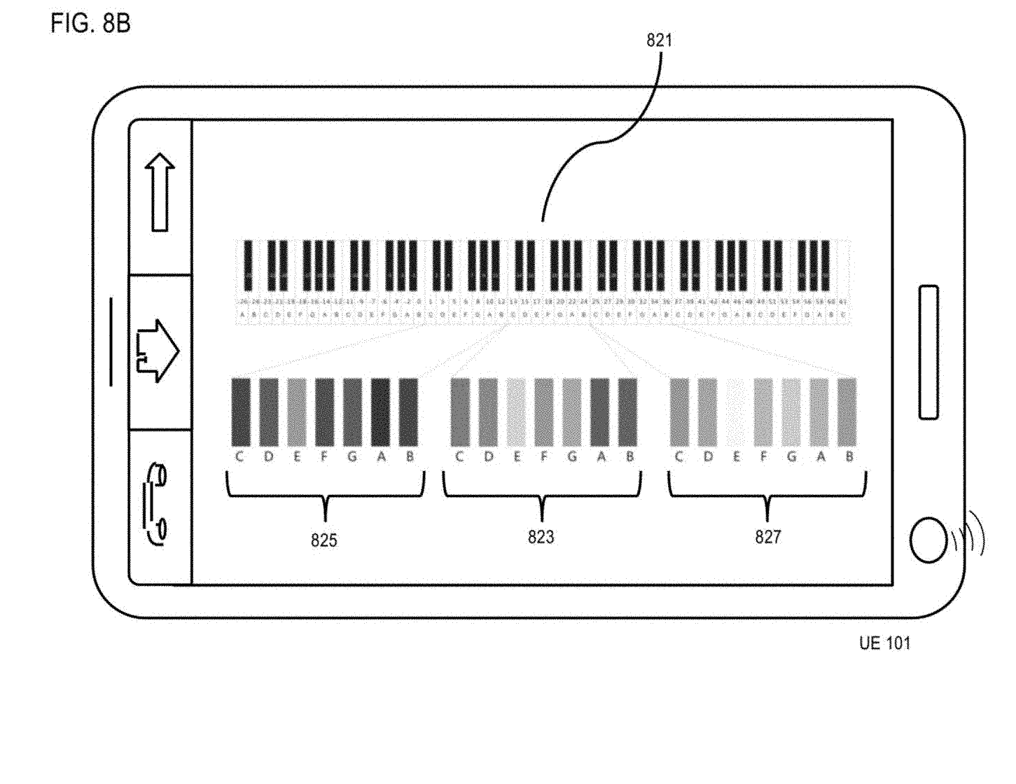

FIGS. 8A-8B are user interface diagrams utilized in the processes of FIGS. 3-6, according to one example embodiment. In one embodiment, a user opens or starts a notation application 107 on the UE 101 to designate a base octave of a musical note range by first determining the applicable music note range based on an input (e.g., sheet music 801). In one instance, the notation platform 103 can determine the musical note range either by an audio (e.g., a microphone) or a visual means (e.g., a scanner). For example, as described above, the UE 101 may include a microphone for sampling audio, or a camera or scanner for capturing visual data. In one embodiment, the notation platform 103 uses one or more OCR techniques to determine the music notes associated with the sheet music 801. As discussed above, given the complexities of conventional music notation, it may be difficult for a child to read a sheet of music to sing or play the corresponding song.

In one embodiment, once the notation platform 103 determines the applicable note range, the notation platform 103 designates a base octave to begin encoding the musical information according to a music notation based on color as described herein. In this instance, the notation platform 103 designates the one-lined octave of the piano note range since it includes the note middle C and, therefore, falls within the middle of the mid-pitched range of piano notes. In one instance, the notation platform 103 then represents the sequence of musical notes as a set of colors. Following the examples described above, the notation platform 103 maps the colors red, orange, yellow, green, cyan, blue and purple to the musical notes C-D-E-F-G-A-B, respectively.

In one embodiment, the notation platform 103 encodes the duration of each musical note of the sheet music 801 according to one or more shapes. In this example, the notation platform 103 represents each note as a rectangle that is colored according to the set of colors, as depicted in the image 803. The notation platform 103 causes, for example, each rectangle to be rendered at a predetermined size, wherein the predetermined size represents a predetermined duration of the musical note (e.g., rectangle 805 represents a quarter E note played one beat). In one embodiment, the notation platform 103 subdivides the predetermined shape into a sub-shape (e.g., a half rectangle) to indicate a musical duration that is less than the predetermined duration (e.g., two eighths notes D 807). Similarly, the notation platform 103 may also concatenate the shape with one or more shapes, in one instance, to indicate a musical note duration greater than the predetermined duration (e.g., half note D 809). Consequently, without any knowledge or experience with conventional music notation as depicted in the sheet music 801, a user can read the colored music notation of image 803 such that the user can appreciate and play or sing the overall music melody and rhythm of the song. In one instance, in addition to enabling the user to link color or its corresponding pitch and to quickly match music notes with pitch through memory, the notation platform 103 can also enable a user to touch each note (e.g., by a finger or a reading pen) so that the user can listen to the sound or pitch of a colored shape to remind the user of the corresponding sound or pitch or to reinforce his or her comprehension of the learned notation.

Referring to FIG. 8B, in one embodiment, a user can open or start a notation application 107 on a UE 101 that includes a virtual piano keyboard 821 or other similar instrument to enable a user to explore the various musical notes of a musical note range. Following the examples described above, in this instance, the notation platform 103 designates the one-lined octave of the piano note range as the base octave and represents the sequence of musical notes of the one-lined octave (e.g., C-D-E-F-G-A-B) as the colors red, orange, yellow, green, cyan, blue and purple, respectively, as shown by the color blocks 823. In one embodiment, the notation platform 103 then repeats the set of colors for each octave of the piano 821. For example, in this instance, the notation platform 103 renders each C note in the color red or a shade or intensity of red, each D note in the color orange or a shade or intensity of orange, and so forth. More specifically, in this example, once the notation platform 103 represents the sequence of musical notes of the base octave as a set of colors as shown by the color blocks 823, the notation platform 103 modifies the intensity of the set of colors for the musical notes of octave lower than the base octave (e.g., the unaccented octave) by darkening the set of colors as depicted by the colors blocks 825. Similarly, the notation platform 103 modifies the intensity of the set of colors for the musical notes of the octave higher than the base octave (e.g., the two-lined octave) by lightening the set of colors as depicted by the color blocks 827. Consequently, when a user touches or gestures with respect to one or more keys of the virtual piano 821, the notation platform 103 renders one or more corresponding colors. It is contemplated that in addition to touching a key of the virtual piano keyboard 821, a user could also use a voice command (e.g., “play C 13”). In addition to rendering the corresponding color block, the notation platform 103 could also audibly render each note to assist the user to memorize pitches and associated colors both visually and audibly.

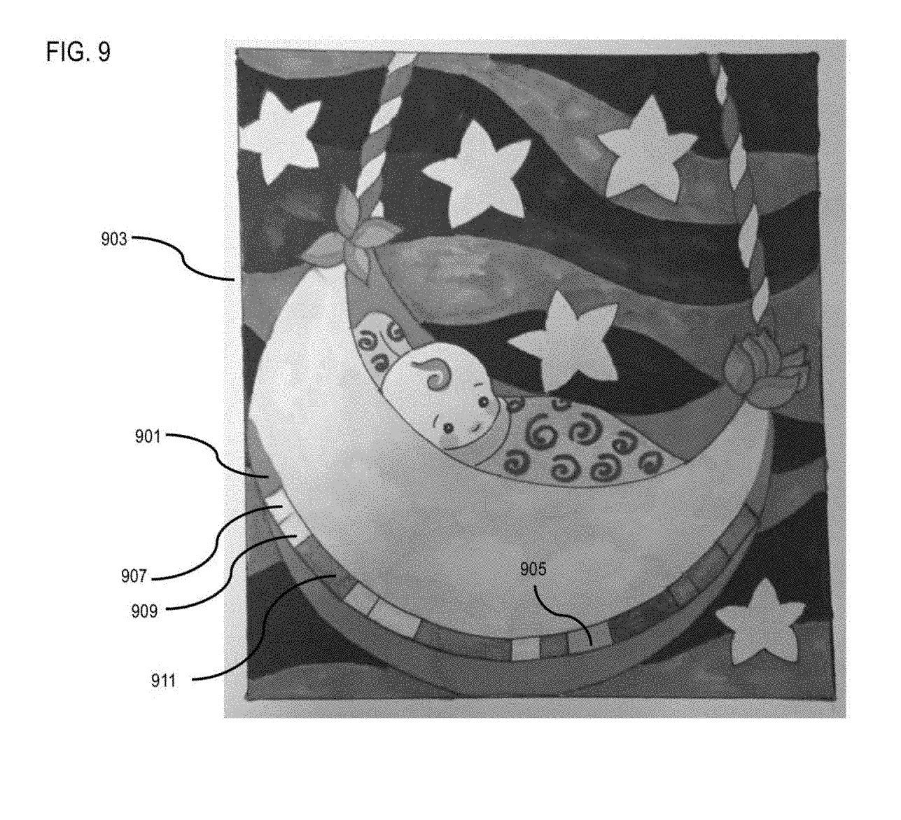

FIG. 9 is an example of a painting including musical information encoded according to the processes of FIGS. 3-6, according to one example embodiment. In this example, the system 100 represents the sequence of musical notes (e.g., a lullaby) as a color strip 901 under the bassinette or bed of the baby in the painting 903. In this instance, the system 100 renders the set of colors of the color strip 901 as orange, yellow, yellow, green, yellow, yellow, green, yellow, green, light right, purple, blue, blue, and green. Following the examples described above with respect to a piano, a user (e.g., a young child) could read the color strip 901 as follows: re-mi-mi-fa-mi-mi-fa and so forth. In this example, the color block 905 is rendered as a light red color. Therefore, the user with knowledge of the notation system should be able to understand and to read or sing the color block 905 with a higher pitch (e.g., C5) than the C note of the base octave (e.g., C4). Further, in this example, the system 100 renders the yellow color bock 907 to represent the predetermined duration of the musical note (e.g., a quarter note) such that the other color blocks represent an equivalent duration of time (e.g., color block 909), a greater duration of time (e.g., color block 911), or a lesser duration of time. Consequently, a user can view the painting and quickly link the color of the blocks to distinctive pitches and the lengths of the color blocks to the duration of the music notes so that the overall music melody and rhythm can be read and/or performed (e.g., singing) by the user.

The processes described herein for encoding musical information according to a music notation based on color may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

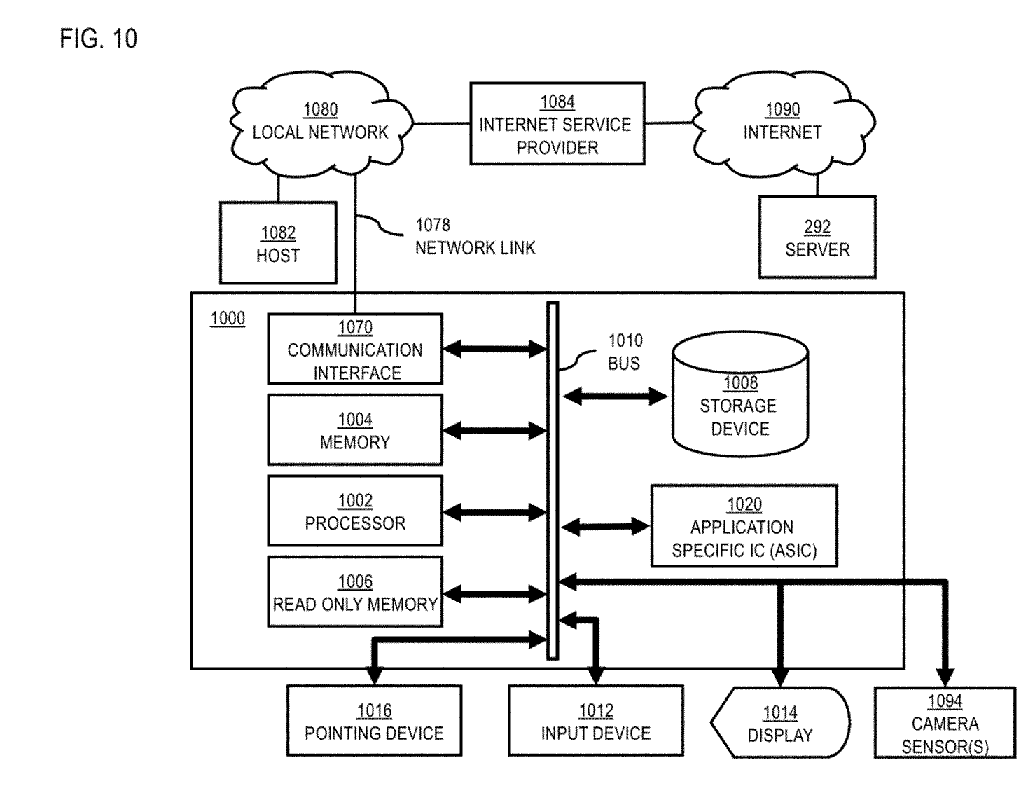

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 11 can deploy the illustrated hardware and components of system 1000. Computer system 1000 is programmed (e.g., via computer program code or instructions) to encode musical information according to a music notation based on color as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000, or a portion thereof, constitutes a means for performing one or more steps of encoding musical information according to a music notation based on color.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to encoding musical information according to a music notation based on color. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1000 also includes a memory 1004 coupled to bus 1010. The memory 1004, such as a random-access memory (RAM) or any other dynamic storage device, stores information including processor instructions for encoding musical information according to a music notation based on color. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for encoding musical information according to a music notation based on color, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014, and one or more camera sensors 1094 for capturing, recording and causing to store one or more still and/or moving images (e.g., videos, movies, etc.) which also may comprise audio recordings. In some embodiments, for example, in embodiments in which the computer system 1000 performs all functions automatically without human input, one or more of external input device 1012, display device 1014 and pointing device 1016 may be omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general, the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals, that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 105 for encoding musical information according to a music notation based on color to the UE 101.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to encode musical information according to a music notation based on color as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of encoding musical information according to a music notation based on color.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RANI, magnetic disk, writable optical disk, etc.) and static memory (e.g., ROM, CD-ROM, etc.) for storing executable instructions that when executed perform the inventive steps described herein to encode musical information according to a music notation based on color. The memory 1105 also stores the data associated with or generated by the execution of the inventive steps.

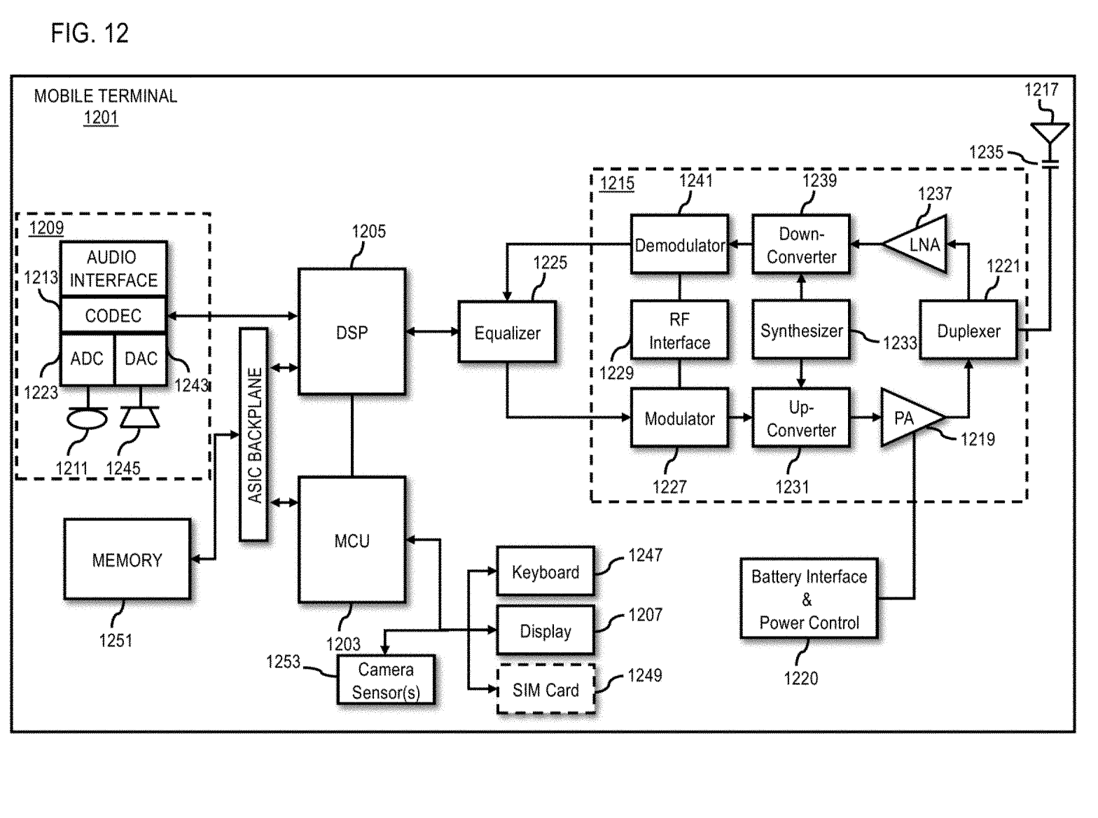

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of encoding musical information according to a music notation based on color. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of encoding musical information according to a music notation based on color.

The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 to encode musical information according to a music notation based on color. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RANI memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

Further, one or more camera sensors 1253 may be incorporated onto the mobile station 1201 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A computer-implemented method for encoding musical information according to a music notation comprising:
designating a base octave of a musical note range comprising a plurality of octaves; wherein the base octave comprises a sequence of musical notes, the sequence of musical notes repeating in each of the plurality of octaves; and
representing the sequence of musical notes as a set of colors,
wherein each color of the set of colors is unique to each note in the sequence of musical notes,
wherein the music notation comprises representing a musical note as a shape that is colored according to the set of colors, and
wherein the shape is augmented with a modification of the set of colors, a symbol, or a combination thereof to indicate that the musical note is in the base octave, a lower octave than the base octave, or a higher octave than the base octave.

2. The method of claim 1, wherein the set of colors is repeated for other octaves of the plurality of octaves, and wherein the modification of the set of colors comprises rendering a different intensity of the set of colors for the other octaves.

3. The method of claim 2, wherein the different intensity for the lower octave is rendered by darkening the set of colors, and wherein the different intensity for the higher octave is rendered by lightening the set of colors.

4. The method of claim 1, wherein the augmenting of the shape with the symbol comprises rendering the symbol at a first position with respect to the shape to indicate the lower octave and at a second position with respect to the shape to indicate the higher octave, and wherein the first position is below the shape, and the second position is above shape.

5. The method of claim 1, wherein the shape is rendered a predetermined size, and wherein the predetermined size represents a predetermined duration of the musical note or a rest.

6. The method of claim 5, wherein the shape is rendered white and augmented with another symbol to indicate the rest.

7. The method of claim 5, wherein the shape is subdivided into a plurality of sub-shapes to indicate a musical note duration or a rest duration less than the predetermined duration, and wherein the shape is concatenated with one or more other shapes to indicate a musical note duration or a rest duration greater than the predetermined duration.

8. The method of claim 7, wherein the shape is subdivided into other sub-shapes that have a different shape than the plurality of sub-shapes, and wherein the other sub-shapes indicate a musical half tone.

9. The method of claim 8, wherein the shape is rendered with another symbol to indicate a musical note duration less than the predetermined duration.

10. The method of claim 1, wherein the shape is grouped with at least one other shape representing at least one other musical note using another symbol or a relative position of the shape to the at least one other shape.

11. An apparatus for encoding musical information according to a music notation comprising:
at least one processor; and
at least one memory including computer program code for one or more programs,
the at least one memory and the computer program code configured to, with the at least one processor, cause the apparatus to perform at least the following,
designate a base octave of a musical note range comprising a plurality of octaves;
wherein the base octave comprises a sequence of musical notes, the sequence of musical notes repeating in each of the plurality of octaves; and
represent the sequence of musical notes as a set of colors,
wherein each color of the set of colors is unique to each note in the sequence of musical notes,
wherein the music notation comprises representing a musical note as a shape that is colored according to the set of colors, and
wherein the shape is augmented with a modification of the set of colors, a symbol, or a combination thereof to indicate that the musical note is in the base octave, a lower octave than the base octave, or a higher octave than the base octave.

12. The apparatus of claim 11, wherein the set of colors is repeated for other octaves of the plurality of octaves, and wherein the modification of the set of colors comprises rendering a different intensity of the set of colors for the other octaves.

13. The apparatus of claim 12, wherein the different intensity for the lower octave is rendered by darkening the set of colors, and wherein the different intensity for the higher octave is rendered by lightening the set of colors.

14. The apparatus of claim 11, wherein the augmenting of the shape with the symbol comprises rendering the symbol at a first position with respect to the shape to indicate the lower octave and at a second position with respect to the shape to indicate the higher octave, and wherein the first position is below the shape, and the second position is above shape.

15. The apparatus of claim 11, wherein the shape is rendered a predetermined size, and wherein the predetermined size represents a predetermined duration of the musical note or a rest.

16. The apparatus of claim 15, wherein the shape is subdivided into a plurality of sub-shapes to indicate a musical note duration or a rest duration less than the predetermined duration, and wherein the shape is concatenated with one or more other shapes to indicate a musical note duration or a rest duration greater than the predetermined duration.

17. A non-transitory computer-readable storage medium for encoding musical information according to a music notation, carrying one or more sequences of one or more instructions which, when executed by one or more processors, cause an apparatus to perform:
designating a base octave of a musical note range comprising a plurality of octaves; wherein the base octave comprises a sequence of musical notes, the sequence of musical notes repeating in each of the plurality of octaves; and
representing the sequence of musical notes as a set of colors,
wherein each color of the set of colors is unique to each note in the sequence of musical notes,
wherein the music notation comprises representing a musical note as a shape that is colored according to the set of colors, and
wherein the shape is augmented with a modification of the set of colors, a symbol, or a combination thereof to indicate that the musical note is in the base octave, a lower octave than the base octave, or a higher octave than the base octave.

18. The non-transitory computer-readable storage medium of claim 17, wherein the set of colors is repeated for other octaves of the plurality of octaves, wherein the modification of the set of colors comprises rendering a different intensity of the set of colors for the other octaves, wherein the different intensity for the lower octave is rendered by darkening the set of colors, and wherein the different intensity for the higher octave is rendered by lightening the set of colors.

19. The non-transitory computer-readable storage medium of claim 17, wherein the augmenting of the shape with the symbol comprises rendering the symbol at a first position with respect to the shape to indicate the lower octave and at a second position with respect to the shape to indicate the higher octave, and wherein the first position is below the shape, and the second position is above shape.

20. The non-transitory computer-readable storage medium of claim 17, wherein the shape is rendered a predetermined size, wherein the predetermined size represents a predetermined duration of the musical note or a rest, wherein the shape is subdivided into a plurality of sub-shapes to indicate a musical note duration or a rest duration less than the predetermined duration, and wherein the shape is concatenated with one or more other shapes to indicate a musical note duration or a rest duration greater than the predetermined duration.
